(19) United States
(12) Patent Application Publication
(10) Pub. No.: US 2017/0361342 A1
(43) Pub. Date: Dec. 21, 2017

(54) METHOD AND SYSTEM OF APPLYING ADHESIVE

(71) Applicant: H.B. Fuller Company, St. Paul, MN (US)

(72) Inventors: Steven L. Scholl, Cottage Grove, MN (US); Larry Souter, Oxford, MI (US); Joseph Sakher, Woodbury, MN (US)

(21) Appl. No.: 15/629,159

(22) Filed: Jun. 21, 2017

Related U.S. Application Data
(60) Provisional application No. 62/352,851, filed on Jun. 21, 2016.

(51) Int. Cl. B05B 7/24; B05B 7/04; B67D 7/72; B05B 15/04

(52) U.S. Cl. CPC B05B 7/2491; B67D 7/72; B05B 7/0491; B05B 7/2494; B05B 15/04

(57) ABSTRACT

A system for applying an adhesive includes an air flow path for conveying compressed air and an adhesive flow path for conveying liquid adhesive. The system includes an air heater coupled to the air flow path and configured to heat the compressed air and a liquid adhesive heater coupled to the adhesive flow path and configured to heat the liquid adhesive. The system also includes an applicator positioned downstream from the air and liquid adhesive heaters. The applicator is configured to receive the liquid adhesive from the adhesive flow path and the compressed air from the air flow path. The applicator is further configured to spray the liquid adhesive from the applicator using the compressed air.

### CROSS-REFERENCE TO RELATED APPLICATION

This application claims the benefit of the U.S. Provisional Application having the Ser. No. of 62/352,851, filed Jun. 21, 2016.

### BACKGROUND

The use of liquid adhesive (i.e. an adhesive that is liquid at room temperature) is known. Such adhesives often have a carrier that can be volatilized (e.g. water, solvent, or mixtures thereof). Heat can be used to assist in this process.

When water is the carrier, the adhesive is referred to as a water-based or waterborne adhesive. Water-based adhesives allow for the application of adhesive without the need to hold tanks of adhesive and hoses that transport the adhesive at elevated temperatures as needed for the application of hot melt adhesives. Further, water-based adhesives often offer a more cost effective solution than hot melt adhesives.

However, water-based adhesives often suffer from slow set times (the time it takes an adhesive to convert into a fixed or hardened state) due to the fact that the water in the adhesive must evaporate before the adhesive is set. Conversely, hot melt adhesives offer the advantage of fast set times as they set immediately upon cooling. A short set time is particularly advantageous on a manufacturing line where longer set times decrease productivity and directly affect throughput of the manufacturing line.

Therefore, improvements to application systems of liquid adhesives are needed.

### SUMMARY

The present disclosure relates generally to a system of applying adhesive. In one possible configuration, and by non-limiting example, the adhesive application system disclosed herein utilizes a heated air flow path and a heated adhesive flow path to dispense adhesive from an applicator.

In a first aspect of the present disclosure, a system for applying an adhesive is disclosed. The system includes an air flow path for conveying compressed air and an adhesive flow path for conveying liquid adhesive. The system includes an air heater coupled to the air flow path and configured to heat the compressed air and a liquid adhesive heater coupled to the adhesive flow path and configured to heat the liquid adhesive. The system also includes an applicator positioned downstream from the air and liquid adhesive heaters. The applicator is configured to receive the liquid adhesive from the adhesive flow path and the compressed air from the air flow path. The applicator is further configured to spray the liquid adhesive from the applicator using the compressed air.

In a second aspect of the present disclosure, a system for applying an adhesive is disclosed. The system includes an air flow path for conveying compressed air and an adhesive flow path for conveying liquid adhesive. The system includes an air heater coupled to the air flow path and configured to heat the compressed air and a heating air line that extends along at least a portion of the air flow path downstream of the air heater. The heating air line is configured to heat the compressed air. The system also includes an applicator positioned downstream from the air heater and heating air line. The applicator is configured to receive the liquid adhesive from the adhesive flow path and the compressed air from the air flow path. The applicator is further configured to spray the liquid adhesive from the applicator using the compressed air.

In a third aspect of the present disclosure, a method for applying a water-based adhesive is disclosed. The method includes receiving compressed air into an air flow path and pumping liquid adhesive from a source of liquid adhesive into an adhesive flow path. The method also includes heating the compressed air in the compressed air flow path using an air heater and heating the liquid adhesive in the adhesive flow path using a liquid adhesive heater. The method includes receiving the liquid adhesive from the adhesive flow path and the compressed air from the air flow path at an applicator and spraying the liquid adhesive from the applicator using the compressed air.

In a fourth aspect of the present disclosure, a method for applying a water-based adhesive is disclosed. The method includes receiving compressed air into an air flow path and pumping liquid adhesive from a source of liquid adhesive into an adhesive flow path. The method also includes heating the compressed air in the compressed air flow path using an air heater and heating the compressed air along at least a portion of the air flow path downstream of the air heater using a heating air line. The method includes receiving the liquid adhesive from the adhesive flow path and the compressed air from the air flow path at an applicator and spraying the liquid adhesive from the applicator using the compressed air.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates a schematic view of an adhesive application system, according to one embodiment of the present disclosure.

FIG. 2 illustrates an example of the adhesive application system of FIG. 1;

FIG. 3 illustrates a schematic view of an air preparing system, according to one embodiment of the present disclosure.

FIG. 4 illustrates an example of the air preparing system of FIG. 3.

FIG. 5 illustrates an example of the air preparing system of FIG. 3.

FIG. 6 illustrates a schematic view of an adhesive preparing system, according to one embodiment of the present disclosure.

FIG. 7 illustrates an example of the adhesive preparing system of FIG. 6.

FIG. 8 illustrates an example of the adhesive preparing system of FIG. 6.

FIG. 9 illustrates a schematic view of a heater system, according to one embodiment of the present disclosure.

FIG. 10 illustrates an example of the heater system of FIG. 9.

FIG. 11 illustrates a schematic view of an applicator, according to one embodiment of the present disclosure.

FIG. 12 illustrates a schematic view of a nozzle, according to one embodiment of the present disclosure.

FIG. 13 illustrates an example of a portion the adhesive application system and the applicator of FIG. 11.

FIG. 14 illustrates an example of a portion the adhesive application system and the applicator of FIG. 11.

FIG. 15 illustrates an example of a portion the adhesive application system and the applicator of FIG. 11.

FIG. 16 illustrates an example of a portion the adhesive application system and the applicator of FIG. 11, including an adhesive line purge valve.

FIG. 17 illustrates a schematic view of a power and control system, according to one embodiment of the present disclosure.

FIG. 18 illustrates an example of the power and control system of FIG. 17.

FIG. 19 illustrates an example of the power and control system of FIG. 17, depicting internal components.

FIG. 20 illustrates a chart of example adhesives capable of being used with the adhesive application system of FIG. 1.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The adhesive application system disclosed herein is configured to use a heated air flow path and a heated adhesive flow path to dispense a water-based adhesive. The heated air flow path and heated adhesive flow path allow for the system to dispense a water-based adhesive that has a lower adhesive set time than other traditional water-based adhesive application systems. A lower set time improves productivity and increases efficiency.

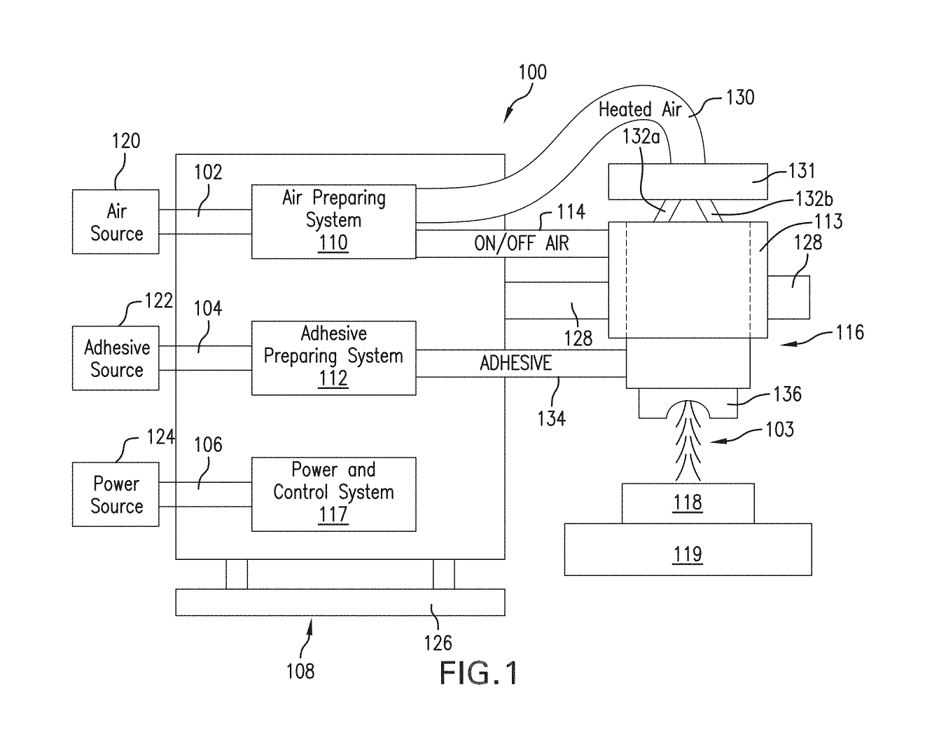

FIG. 1 shows an adhesive application system 100. The system 100 includes an air input 102, an adhesive input 104, and a power input 106. The adhesive application system 100 also includes a frame 108, an air preparing system 110, an adhesive preparing system 112, an applicator 116, and a power and control system 117.

The system 100 is configured to deliver a water-based adhesive 103 to a sprayable media 118. In some embodiments, the sprayable media 118 is a chipboard, an air filter substrate, or other surface where an adhesive is needed. In some embodiments, the system 100 can be positioned on or near a conveyor 119, or like conveying system, so that the system 100 can apply the adhesive 103 to a plurality of sprayable media 118 in a short amount of time.

The air input 102 is configured to receive an air flow from an air source 120 that is external to the system 100. In some embodiments, the air source 120 is a compressor that provides compressed air to the air input 102. In some embodiments, the air source 120 can provide compressed air to the air input 102 of between about 5 psi and 50 psi, or even between about 20 psi and 35 psi. In still other embodiments, the air source 120 can provide compressed air to the air input 102 of between about 25 psi and 30 psi. The air source 120 can be positioned in close proximity to the system 100 or, in other embodiments, the air source 120 can be an air line that connects to a compressed air system in a building (i.e., a manufacturing facility). In some embodiments, the air input 102 is configured to provide compressed air to the air preparing system 110 and the adhesive preparing system 112.

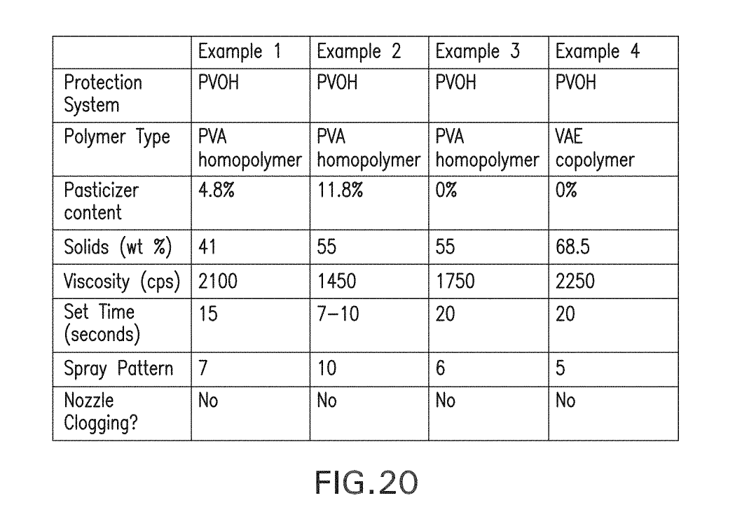

The adhesive input 104 is configured to receive a flow of water-based adhesive 103 from an adhesive source 122. In some embodiments, the adhesive source 122 is a holding tank. The type of adhesive 103 will be described in more detail with respect to FIG. 20

The power input 102 is configured to receive power from a power source 124. The power source 124 can be in the form of AC or DC power. In some embodiments, the system 100 can be attached to a 240 volt AC power source in a facility such as a manufacturing facility.

The frame 108 of the system 100 is configured to stabilize and support the system 100. In some embodiments, the frame 108 includes a main frame 126 and frame arm 128. The frame arm 128 can be either fixed or movable about the main frame 126. The frame arm 128 is configured to support the applicator 116. When movable about the main frame 126, the frame arm 128 can be selectively positioned to control the direction and distance at which the system 100 applies sprayed adhesive 103. This can be advantageous when needing to apply adhesive 103 to sprayable media 118 that has a complicated shape or unwieldy size.

The main frame 126 is configured to be positioned or mounted to a variety of different surfaces. For example, the main frame 126 can be mounted to a floor, beam, or other support structure in a manufacturing facility. In other embodiments, the frame is not fixed to a surface, thereby making the system 100 portable.

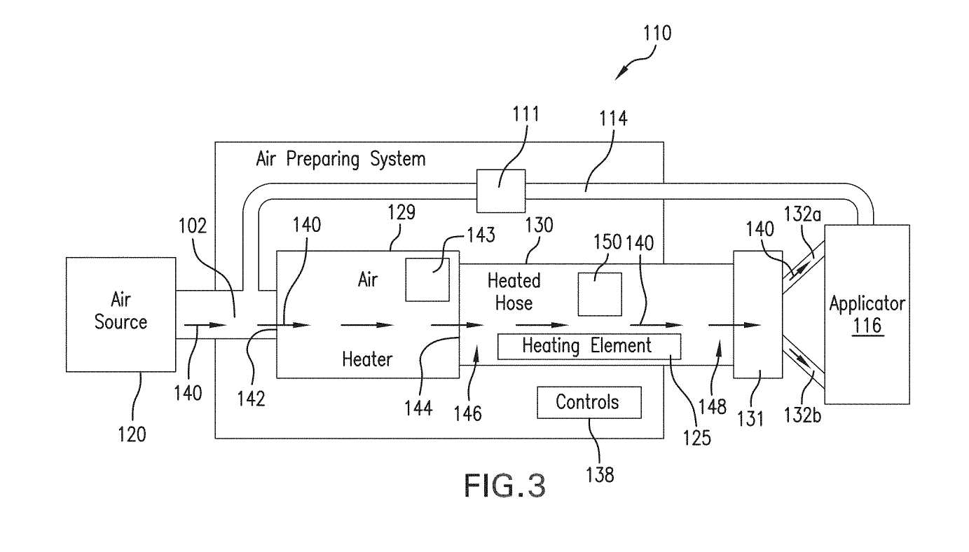

The air preparing system 110 is configured to receive an air flow from the air source 120 at the air input 102, treat the air flow, and convey the air flow along an air flow path to the applicator 116. The air preparing system 110 conveys the air through a heating air line 127. The heating air line 127 includes a heated hose 130, a manifold 131, and a pair of air lines 132a, 132b. Air travels through the heated hose 130 to the manifold 131 and through the pair of air lines 132a, 132b, which connect to the applicator 116. The heated hose 130 connects a portion of the air preparing system 110 with the manifold 131. The air preparing system 110 will be described in more detail with respect to FIGS. 3-5 and FIGS. 9-10.

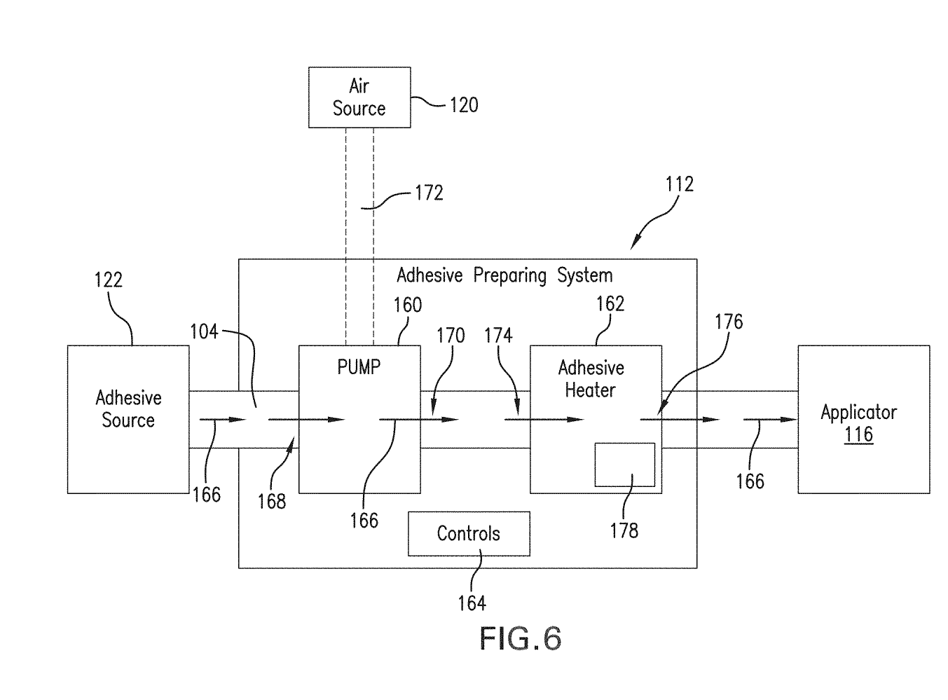

The adhesive preparing system 112 is configured to receive the adhesive 103 from the adhesive source 122 at the adhesive input 104, treat the adhesive 103, and convey the adhesive 103 along an adhesive flow path to the applicator 116. The adhesive preparing system 112 conveys adhesive 103 along an adhesive line 134 to the applicator 116. The adhesive preparing system 112 will be described in more detail with respect to FIGS. 6-10.

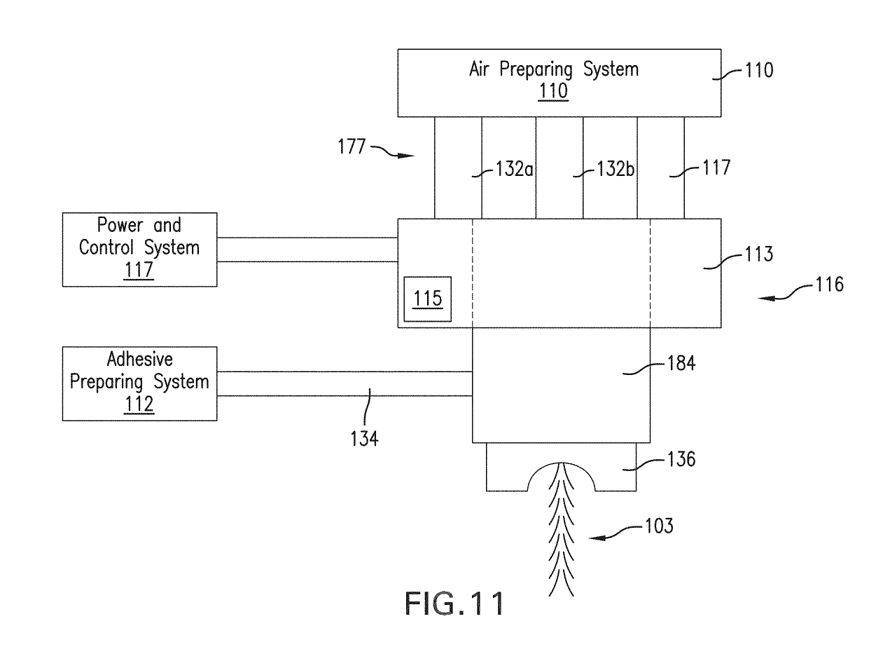

The applicator 116 is operable by compressed air: however, in some embodiments the applicator 116 is operable, or triggered, mechanically. In some embodiments, the applicator 116 includes an applicator heater 113 that at least partially surrounds the applicator 116. In particular, the applicator 116 is configured to receive air from the air preparing system 110 via a trigger line 114, air from the air preparing system 110 via the heating air line 127, and adhesive 103 from the adhesive preparing system 112 via the adhesive line 134. The applicator 116 is configured to deliver a spray of adhesive 103 from a nozzle 136 using the compressed air. In some embodiments, the applicator 116 is configured to deliver an atomized spray of adhesive 103 to the sprayable media 118. In other embodiments, the applicator 116 is configured to deliver a bead of adhesive 103 to the sprayable media 118. The applicator 116 can be manually operated or it can be automatically operated by the power and control system 117. The applicator 116 will be described in more detail with respect to FIGS. 11-16.

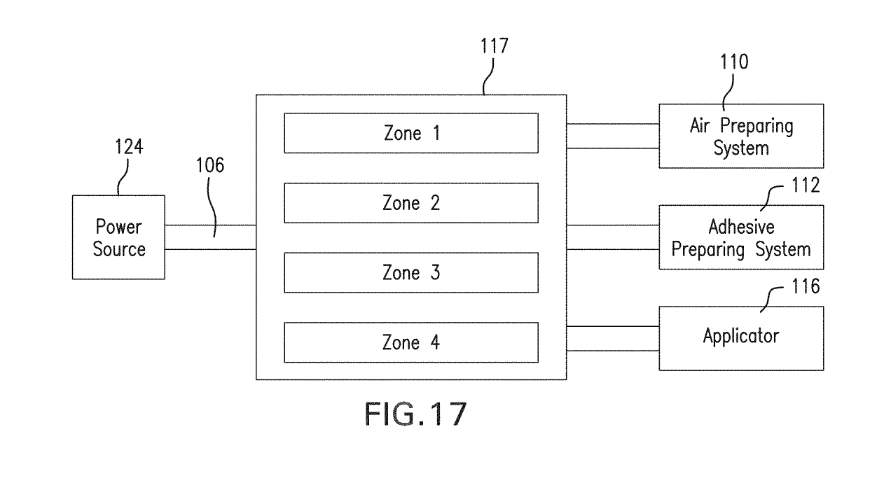

The power and control system 117 is configured to at least partially control the operation of the air preparing system 110, the adhesive preparing system 112, and the applicator 116. The power and control system 117 can also be configured to distribute power received at the power input 106 from the power source 124 to different components of the system 100. The power and control system 117 will be described in more detail with respect to FIGS. 17-20.

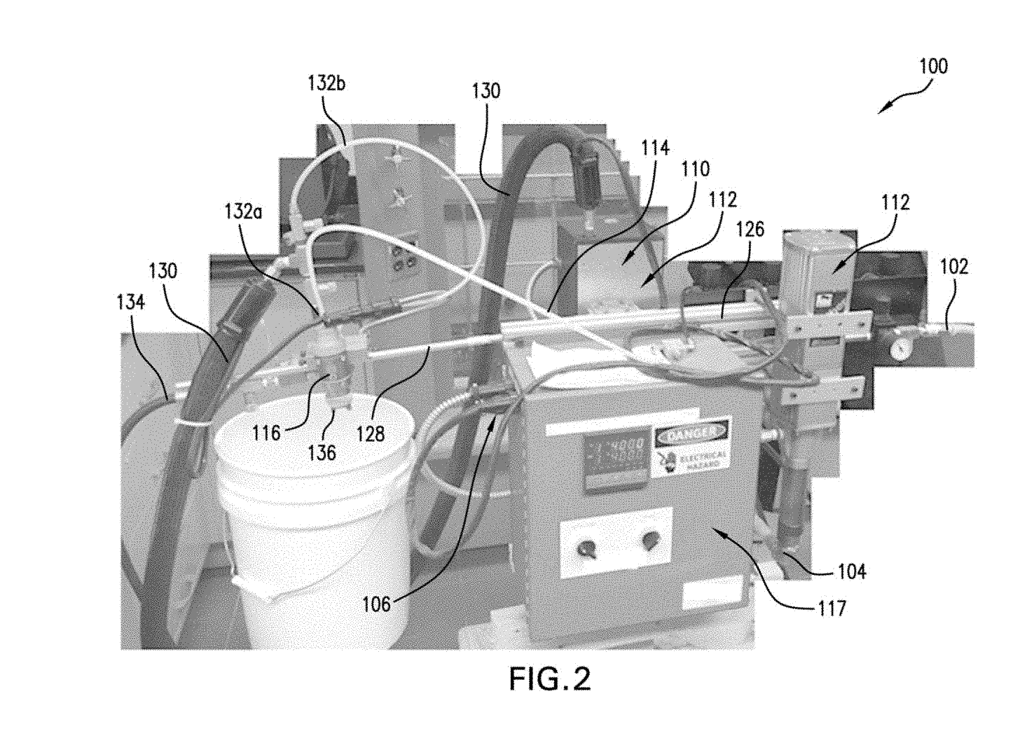

FIG. 2 shows an example of the adhesive application system 100. The air preparing system 110, adhesive preparing system 112, and power and control system 117 are shown mounted to the main frame 126. The applicator 116 is shown mounted to the frame arm 128.

FIG. 3 shows the air preparing system 110. The air preparing system 110 includes an air heater 129, the heating air line 127, a trigger line 114, and a set of air preparing controls 138. As shown, the heating air line 127 includes the heated hose 130, the manifold 131, and the pair of air lines 132a, 132b. The air preparing system 110 is configured to convey air from the air source 120 along an air flow path 140 to the applicator 116.

The air heater 129 is a heater that is powered by electricity and is configured to heat the compressed air received from the air input 102, upstream from the applicator 116. In some embodiments, the air heater 129 receives electric power from the power source 124 via the power and control system 117. The air heater 129 includes an inlet 142 and an outlet 144. At the inlet 142, compressed air enters the air heater 129 and begins receiving heat generated by the air heater 129. At the outlet 144, compressed air exits the air heater 129 via the heated hose 130 at a temperature higher than it entered.

In some embodiments, the air heater 129 is an aluminum block heater, alternatively the block heater can comprise stainless steel, a ceramic or a coated metal. The compressed air that enters at the inlet 142 takes a serpentine path through a plurality of interior sealed channels (not shown) within the heater 129 until the air exits at the outlet 144. Therefore, the air exiting the air outlet 144 is at a higher temperature than the air entering at the air inlet 142. Air flow through the heater 129 is provided by the air source 120 (e.g., a compressor).

In some embodiments, the air heater 129 is configured to heat the air along the air flow path 140 to a temperature of between about 300 degrees Fahrenheit and about 450 degrees Fahrenheit, to a temperature of between about 350 degrees Fahrenheit and about 450 degrees Fahrenheit, or even to a temperature between about 375 degrees Fahrenheit and about 425 degrees Fahrenheit. In some embodiments, the air heater 129 is configured to heat the air along the air flow path 140 to about 400 degrees Fahrenheit. In some embodiments, the air heater 129 includes a temperature sensor such as a resistance temperature detector (RTD) 143 to monitor the temperature of the air heater 129. In some embodiments, the RTD 143 is in communication with the power and control system 117 so that the power and control system 117 can automatically adjust the temperature of the air heater 129 based on the temperature measurement from the RTD 143. In other embodiments, the air heater 129 includes a thermocouple instead of an RTD. In some embodiments, the air heater 129 is a 400 watt heater.

The heating air line 127 is configured to extend along at least a portion of the air flow path 140, downstream of the air heater 129. The heating air line 127 is further configured to apply heat to the compressed air within the air flow path 140 between the air heater 129 and the applicator 116. Specifically, the heating air line 127 is configured to deliver a heated atomization air flow and a heated fan air flow to the applicator 116. The heating air line 127 includes the heated hose 130, manifold 131, and air lines 132a, 132b.

The heated hose 130 is flexible and extends along at least a portion of the air flow path 140 downstream of the air heater 129. The heated hose 130 is configured to apply heat to the compressed air leaving the air outlet 144 of the air heater 129. In some embodiments, the heated hose 130 raises the temperature of the compressed air passing therethrough. In other embodiments, the heated hose 130 is configured to maintain the temperature of the air passing therethrough at or above a present temperature value.

At a first end 146, the heated hose 130 is fluidly connected to the air outlet 144 of the air heater 129 and, at an opposite second end 148, the heated hose 130 is fluidly connected to the manifold 131. Air flows in a sealed channel within the heated hose 130 from the first end 146 to the second end 148. In some embodiments, the heated hose 130 surrounds the majority of the air lines 132a, 132b.

The heated hose 130 includes a heating element 125 disposed therein. In some embodiments, the heating element 125 is a coiled wire that is configured to heat an interior channel of the heated hose 130. The heating element 125 can travel the length of the heated hose 130 and can be circumferentially positioned around the interior channel of the heated hose 130. In some embodiments, the heating element 125 is a 25 watts/foot heating element capable of being powered by the power and control system 117. In some embodiments, the heated hose 130 includes a layer of thermal insulation around the heating element 125 to aid in heat retention. The amount of insulation can be varied to improve the heat retention properties of the heated hose 130. Around the insulation, in some embodiments, the heated hose 130 includes an outer protective layer, such as a polyamide braided sheath. The outer protective surface serves to protect the interior components from abrasion and allows for safe handling of the heated hose 130. In some embodiments, the heated hose 130 can include a strength member embedded therein, such as a stainless steel braided sheath.

In some embodiments, the heated hose 130 includes a temperature sensor 150 such as an RTD or thermocouple. In some embodiments, like the RTD 143 of the air heater 129, the power and control system 117 is in communication with the temperature sensor 150 of the heated hose 130 so as to allow the power and control system 117 to control the behavior of the heated hose 130, such as its operating temperature.

In some embodiments, the heated hose 130 is about six feet in overall length from the first end 146 to the second end 148. In some embodiments, the heated hose 130 has a #6 core size having an internal channel diameter of about ⅝ inches. In other embodiments still, the heated hose 130 is configured to be operated between about 350 degrees Fahrenheit and about 450 degrees Fahrenheit, or even between about 375 degrees Fahrenheit and about 425 degrees Fahrenheit In some embodiments, the heated hose 130 is configured to heat the air along the air flow path 140 to about 400 degrees Fahrenheit.

A variety of combinations of heating elements and thermal insulation that form a heated/insulated passage between the air heater 129 and the applicator 116 including, but not limited to, a heated hose 130, may be utilized and is considered within the scope of the present disclosure.

The manifold 131 allows air flow to be transferred from the heated hose 130 to the air lines 132a, 132b and then to the applicator 116. The air lines 132a, 132b are configured to create a sealed fluid connection between to the manifold 131 and the applicator 116. In some embodiments, the air lines 132a, 132b are silicon tubing. In some embodiments, the air lines 132a, 132b are disposed with the heated hose 130, eliminating the need for a manifold. In such an embodiment, the air lines 132a, 132b are configured to create a sealed fluid connection between the outlet 144 of the air heater 129 and the applicator 116. Also in such an embodiment, the air lines 132a, 132b are configured to be insulated and/or receive heat from the heated hose 130. In some embodiments, the air line 132a supplies atomization air flow to the applicator 116 and the air line 132b supplies fan air flow to the applicator. This will be discussed in more detail with respect to FIGS. 11-16.

The trigger line 114 is configured to selectively convey compressed air from the air input 102 to the applicator 116 so as to cycle the applicator 116 between an on (i.e., spraying) and an off (i.e., not spraying) operation. In some embodiments, the trigger line 114 includes a valve 111 that can be either manually or automatically operated to either allow air flow along the trigger line 114 or block air flow along the trigger line 114. In the depicted embodiment, the trigger line 114 bypasses the air heater 129 and the heated hose 132. In some embodiments, the trigger line 114 is controlled by the air preparing controls 138 and/or the power and control system 117.

The air preparing controls 138 are configured to alter the flow and pressure of air through the system 100. Specifically, the air preparing controls 138 are configured to allow a user to alter the pressure at which the air is provided to the applicator 116 via air lines 132a, 132b and via the trigger line 114. In some embodiments, the air preparing controls 138 are controlled by the power and control system 117.

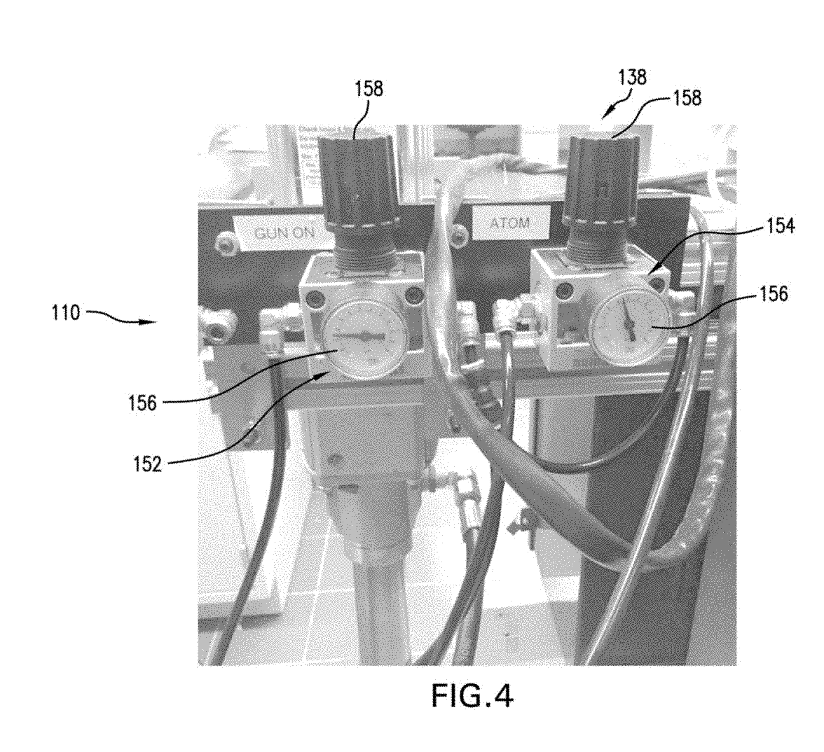

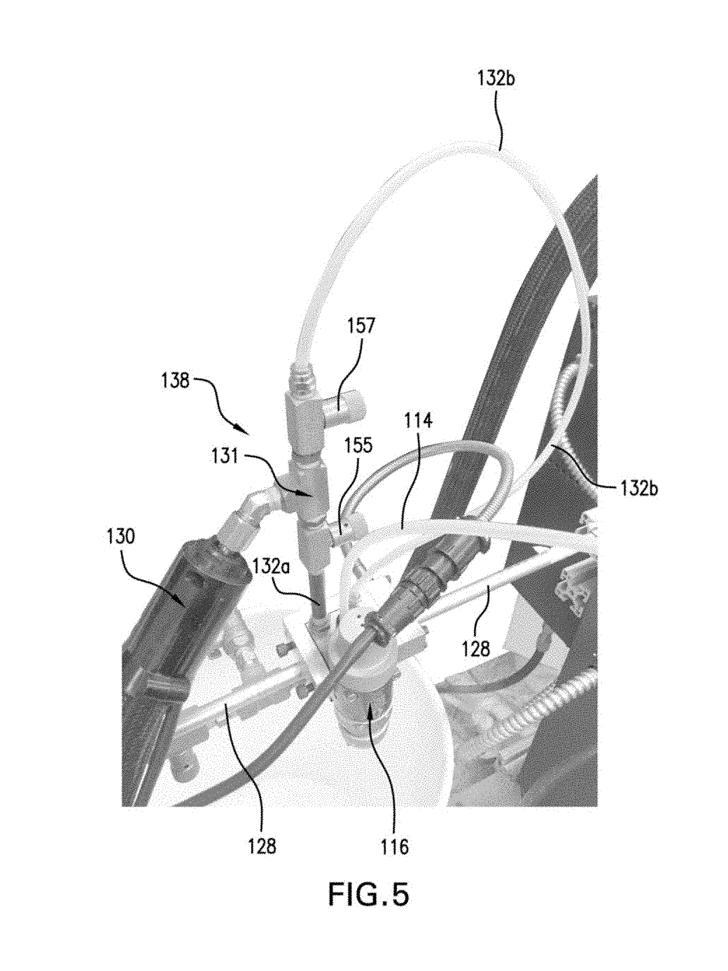

Examples of the air preparing controls 138 are shown in FIGS. 4 and 5. As shown in FIG. 4, a regulator 152 is shown to control the pressure being delivered to the applicator 116 via the trigger line 114. A second regulator 154 is shown to control the pressure being delivered to the applicator 116 via the heating air line 127. Each regulator 152, 154 includes a pressure gauge dial 156 and an adjustment knob 158. Each regulator 152, 154 is configured to selectively control the air pressure being delivered to the heating air line 127 and the trigger line 114, respectively. In other embodiments, the preparation controls 138 are digital and can be adjusted via the power and control system 117 of the adhesive application system 100.

FIG. 5 shows an example of the air preparing controls 138 located near the applicator 116 at the manifold 131. As shown, a fine adjustment knob 155 is disposed on the air line 132a and a similar fine adjustment knob 157 is shown on air line 132b. The fine adjustment knobs 155, 157 allow the user to further fine tune the air flow and pressure that is delivered to the applicator 116 via lines air 132a, 132b. Therefore, in some embodiments, the regulator 154, shown in FIG. 4, can be used for gross regulation of the air flow along the heating air line 127, while the fine adjustment knobs 155, 157 can be used for finer adjustments to the air flow in air lines 132a, 132b.

FIG. 6 shows the adhesive preparing system 112. The adhesive preparing system 112 includes a pump 160, an adhesive heater 162, and a set of adhesive preparation controls 164. The adhesive preparing system 112 is configured to convey adhesive 103 from the adhesive source 122 along an adhesive flow path 166 to the applicator 116.

The pump 160 is configured to create a flow of adhesive 103 from the adhesive source 122 along the adhesive flow path 166. As shown, the pump 160 is internal to the system 100, specifically to the adhesive preparing system 112. However, in some embodiments, the pump 160 can be positioned exterior to the system 100. For example, the pump 160 can be positioned with the adhesive source 122.

The pump 160 includes an inlet 168 and an outlet 170. The pump 160 draws adhesive 103 from the adhesive source 122 through the adhesive input 104 to the inlet 168 of the pump. The pump 160 then pushes the adhesive 103 out of the outlet 170 along the adhesive flow path 166 to the applicator 116.

In some embodiments, the pump 160 is a piston pump powered by the air source 120 via a pump air line 172. In some embodiments, the maximum air input pressure via pump air line 172 is about 125 psi. In other embodiments, the maximum fluid pressure of the pump 160 is about 625 psi.

The adhesive heater 162 receives adhesive flow from the pump 160 along the adhesive flow path 166. The adhesive heater 162 is substantially similar to the air heater 129, described above. The adhesive heater 162 is a heater that is powered by electricity and is configured to apply heat to the adhesive 103 from the adhesive source 122. In some embodiments, the adhesive heater 162 receives electric power from the power and control system 117. The adhesive heater 162 includes an inlet 174 and an outlet 176. At the inlet 174, adhesive 103 enters the adhesive heater 162 and begins receiving heat generated by the air heater 129 until the adhesive 103 exits at the outlet 176.

In some embodiments, the adhesive heater 162 is an aluminum block heater, alternatively the adhesive heater can comprise stainless steel, a ceramic or a coated metal. The adhesive 103 that enters at the inlet 174 takes a serpentine path through a plurality of interior sealed channels within the adhesive heater 162, and exits at the outlet 176. The adhesive 103 exiting the adhesive heater outlet 176 is at a higher temperature than the adhesive 103 entering at the heater inlet 174.

In some embodiments, the adhesive heater 162 is configured to heat the adhesive 103 along the adhesive flow path 166 to a temperature between about 75 degrees Fahrenheit and about 300 degrees Fahrenheit, between about 120 degrees Fahrenheit and about 210 degrees Fahrenheit, or even between about 140 degrees Fahrenheit and about 170 degrees Fahrenheit. In some embodiments, the adhesive heater 162 is configured to heat the adhesive 103 along the adhesive flow path 166 to about 170 degrees Fahrenheit. Similar to the air heater 129, the adhesive heater 162 can include a temperature sensor such as an RTD 178. In some embodiments, the RTD 178 is in communication with the power and control system 117 so that the power and control system 117 can automatically adjust the temperature of the adhesive heater 162 based on a temperature measurement taken by the RTD. In other embodiments, the adhesive heater 162 includes a thermocouple instead of an RTD. In some embodiments, the adhesive heater 162 is a 400 watt heater.

The adhesive preparation controls 164 are configured to alter the flow of adhesive 103 through the system 100. Specifically, the adhesive preparation controls 164 are configured to allow a user to alter the flow rate at which the adhesive 103 is provided to the adhesive heater 162 and to the applicator 116 via the adhesive line 134. In some embodiments, the adhesive preparation controls 164 are in communication with the power and control system 117.

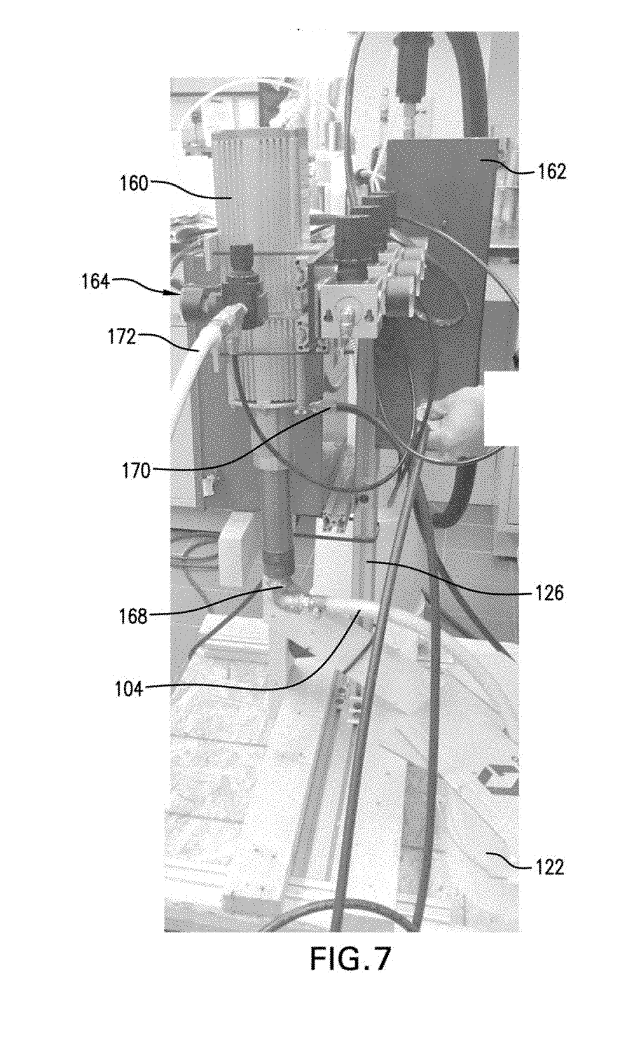

An example of the adhesive preparing system 112 is shown in FIG. 7. The adhesive preparing system 112 is shown mounted to the main frame 126 of the system 100.

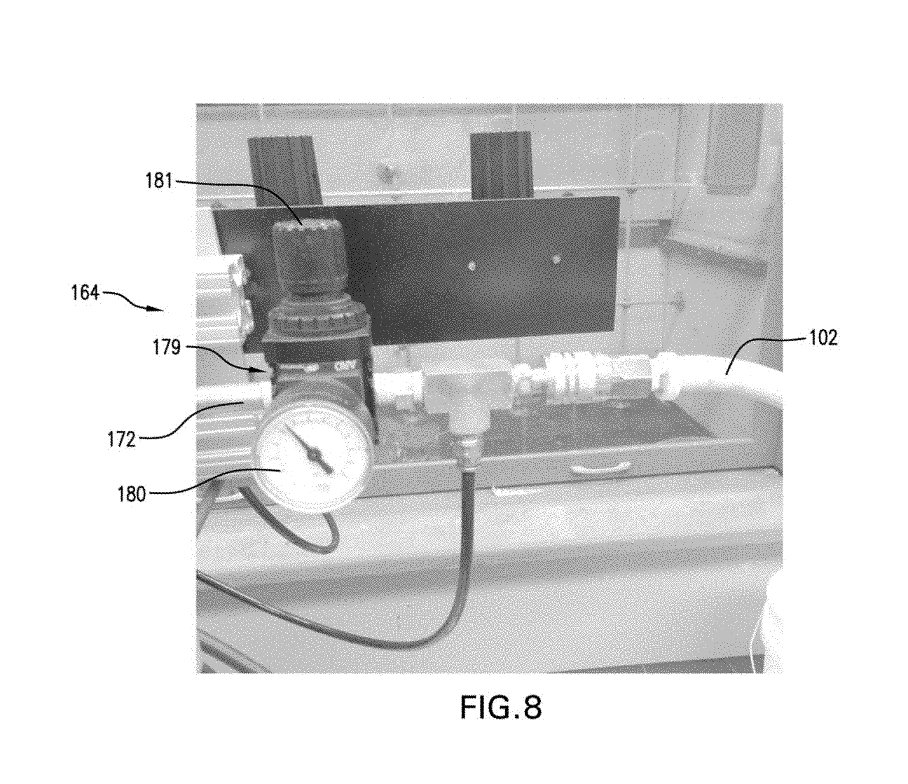

An example of the adhesive preparation controls 164 is shown in FIG. 8. As shown, a regulator 179 is shown to be connected to the pump air line 172. The regulator 179 is configured to alter the amount of compressed air that is delivered to the pump 160. By altering the amount of compressed air delivered to the pump 160, the regulator 179 can alter the output of flow of the adhesive 103 from the pump (i.e., varying the displacement). The regulator 179 includes a pressure gauge dial 180 and an adjustment knob 181. In some embodiments, like the air preparing controls 138, the adhesive preparation controls 164 can include fine adjustment controls located near the applicator 116 along the adhesive line 134. In other embodiments, the controls 164 are digital.

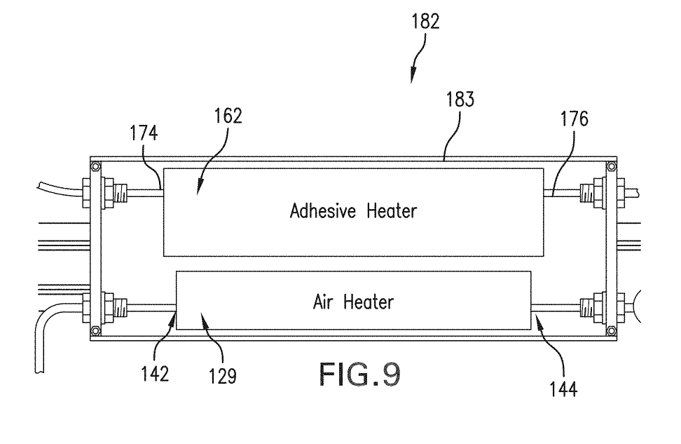

FIG. 9 shows an example heater system 182 that includes the air heater 129 and the adhesive heater 162. The heaters 129, 162 are contained within a single housing 183. Because both heaters 129, 162 operate similarly, containing both within a single housing 183 can offer advantages to the system 100 such as easing serviceability, reducing heat loss of the heaters 129, 162 to other parts of the adhesive application system 100, and improving safety by shielding the heaters 129, 162 with the housing 183. In some embodiments, the housing 183 can be insulated to help reduce heat loss.

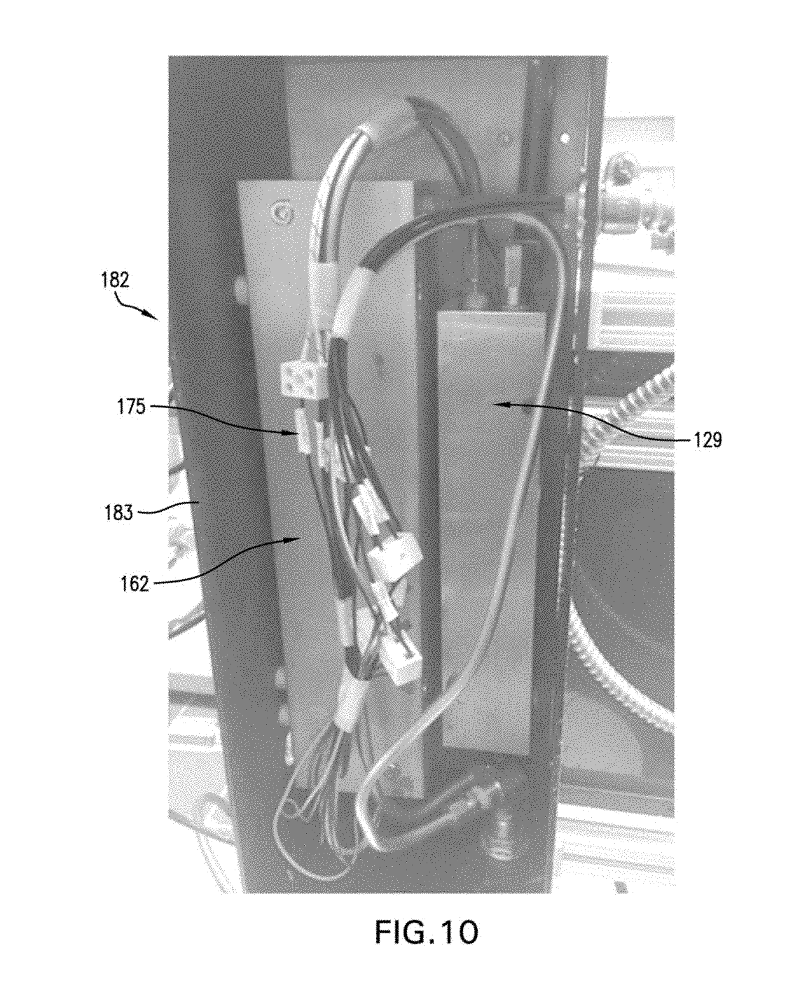

FIG. 10 shows an example of the heater system 182. In the example, a plurality of electrical connections 175 are shown to be contained within the housing 183. The electrical connections 175 can deliver power and control signals to the air and adhesive heaters 129, 162 from the power source 124 and/or the power and control system 117.

FIG. 11 shows a schematic of the applicator 116. The applicator 116 includes the applicator heater 113, an applicator body 184, a plurality of inputs 177, and the nozzle 136. The applicator 116 is configured to deliver an atomized spray of the adhesive 103, delivered from the adhesive line 134, to the sprayable media 118.

The applicator heater 113 is configured to apply heat to the applicator 116, specifically the applicator body 184. By heating the applicator body 184, heated air entering via air lines 132a, 132b is less likely to substantially lower in temperature once entering the applicator body 184 and prior to being expelled from the nozzle 136. The applicator heater 113 can be a block heater that at least partially surrounds the applicator body 184. In some embodiments, the applicator heater 113 includes an electric heating element.

The applicator heater 113 is in communication with the power and control system 117 so that the power and control system 117 can alter the temperature of the applicator heater 113. In some embodiments, the applicator heater 113 includes a temperature sensor 115 that is configured to measure the temperature of the applicator heater 113. In some embodiments, the applicator heater 113 is maintained at a temperature of between room temperature and about 300 degrees Fahrenheit, between about 120 degrees Fahrenheit and about 210 degrees Fahrenheit, or even between about 140 degrees Fahrenheit and about 170 degrees Fahrenheit In other embodiments, the applicator heater 113 is maintained at a temperature of about 150 degrees Fahrenheit.

As mentioned above, the applicator 116 includes a plurality of inputs 177 that are configured to receive the air lines 132a, 132b, the trigger line 114, and the adhesive line 134. The air line 132a delivers heated atomization air to the applicator, the air line 132b delivers heated fan air to applicator 116, the trigger line 114 delivers air that is configured to cycle the applicator between on/off, and the adhesive line 134 delivers heated adhesive 103 to the applicator 116. In some embodiments, the adhesive line 134 enters the applicator 116 on the applicator body 184 away from the applicator heater 113.

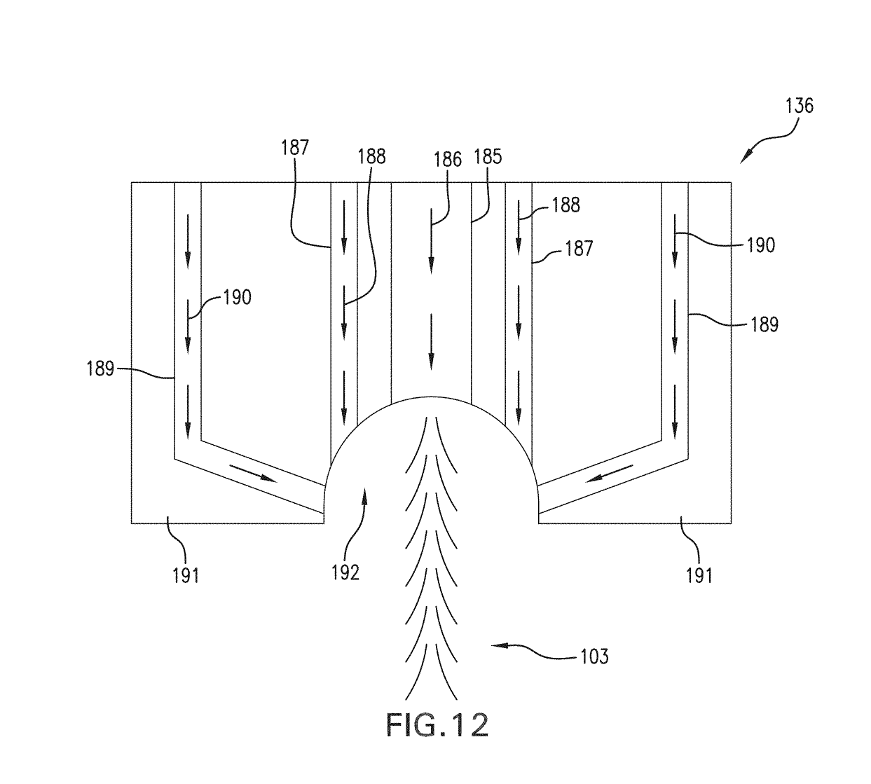

An example nozzle 136 is shown in FIG. 12. The nozzle 136 is configured to help apply a spray of adhesive 103 to the sprayable media 118. The nozzle 136 includes an adhesive channel 185 in which an adhesive stream 186 of adhesive 103 flows, atomization air channels 187 in which atomization air streams 188 flow, and fan air channels 189 in which fan air streams 190 flow. The fan air channels 189 are positioned within fins 191 on the nozzle 136, away from the atomization air channels 187 and the adhesive channel 185 which are positioned in a pocket 192 of the nozzle 136. The nozzle 136 is configured to allow the applicator 116 to apply the atomization air streams 188 (from air line 132a) and the fan air streams 190 (from air line 132b) to the adhesive stream 186 as it leaves the applicator 116. The atomization air streams 188 and the fan air streams 190 help to atomize and shape the spray of adhesive 103.

Because the atomization air streams 188 and the fan air streams 190 are heated by the heating air line 127, and the applicator body 184 is heated by the applicator heater 113, heated compressed air exits the nozzle 136 at a temperature that aids in vaporizing at least a portion of the water content of the adhesive 103 in the adhesive stream 186. By vaporizing the adhesive 103 leaving the applicator 116, the time that the adhesive 103 takes to set (e.g., set time) can be controlled. In some embodiments, the set time is lower (i.e., faster) when compared to a system using unheated atomizing and fan air. By lowering the set time, productivity can be increased and less adhesive 103 is used from the adhesive source 122, which is cost effective.

In some embodiments the applicator 116 includes a zero cavity needle to selectively open and close the adhesive channel 185. The zero cavity needle prevents adhesive build up in the adhesive channel 185 to prevent the applicator 116 from clogging. In some embodiments, the zero cavity needle is attached to a spring-loaded plunger that resides in a cavity in the applicator body 184. The needle can be biased to a closed position and then move to an open position so as to expel adhesive 103 from the applicator 116, thereby overcoming the spring force when the cavity receives air from the trigger line 114.

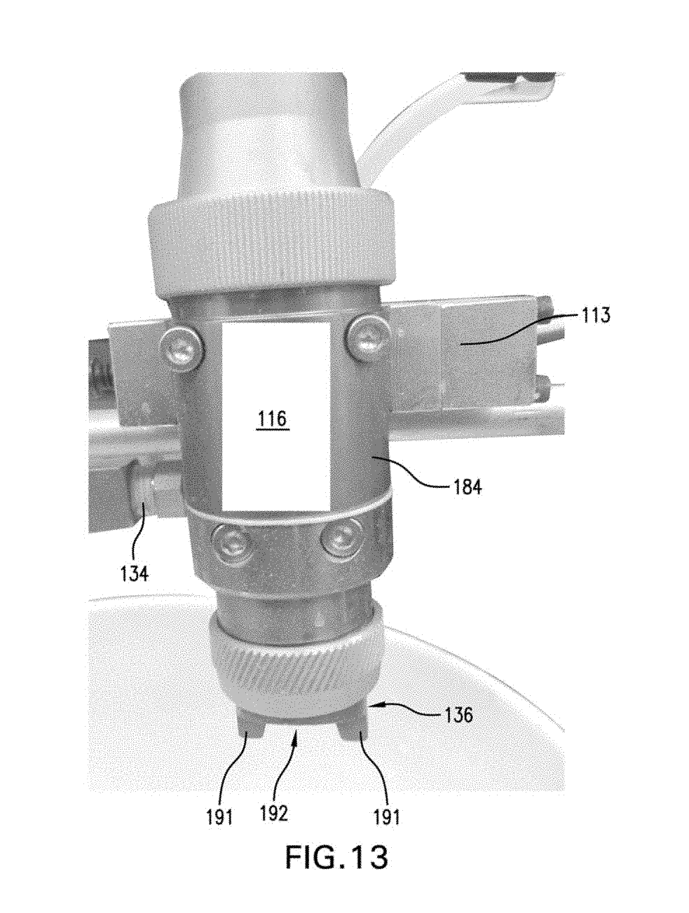

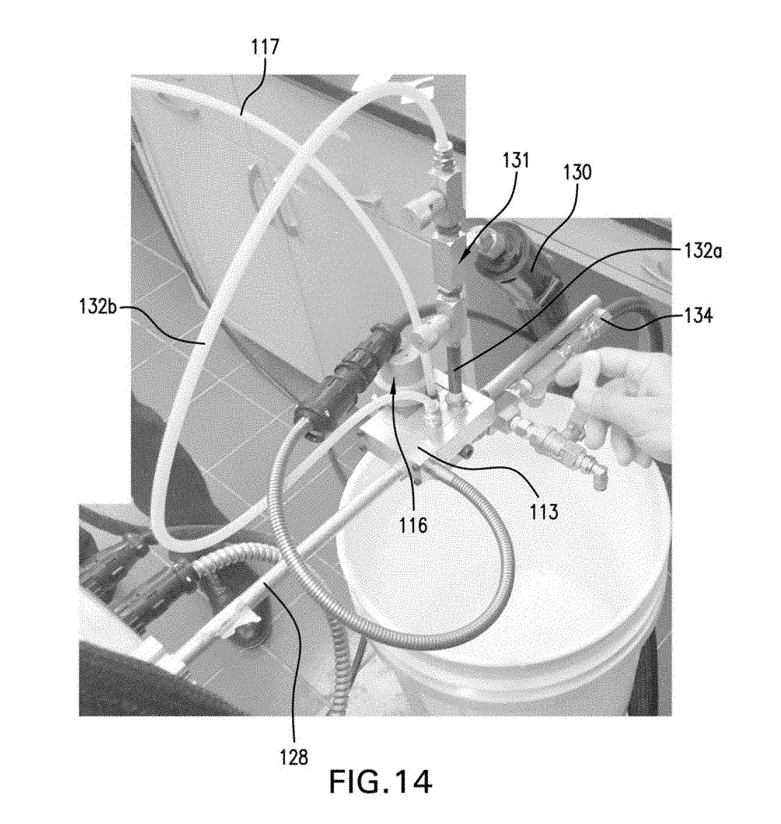

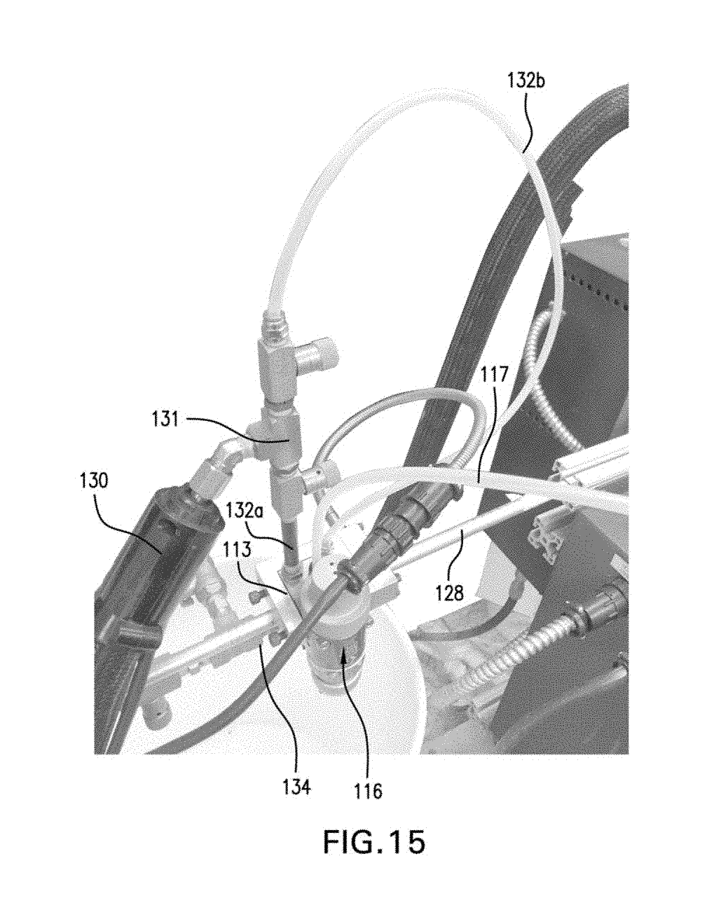

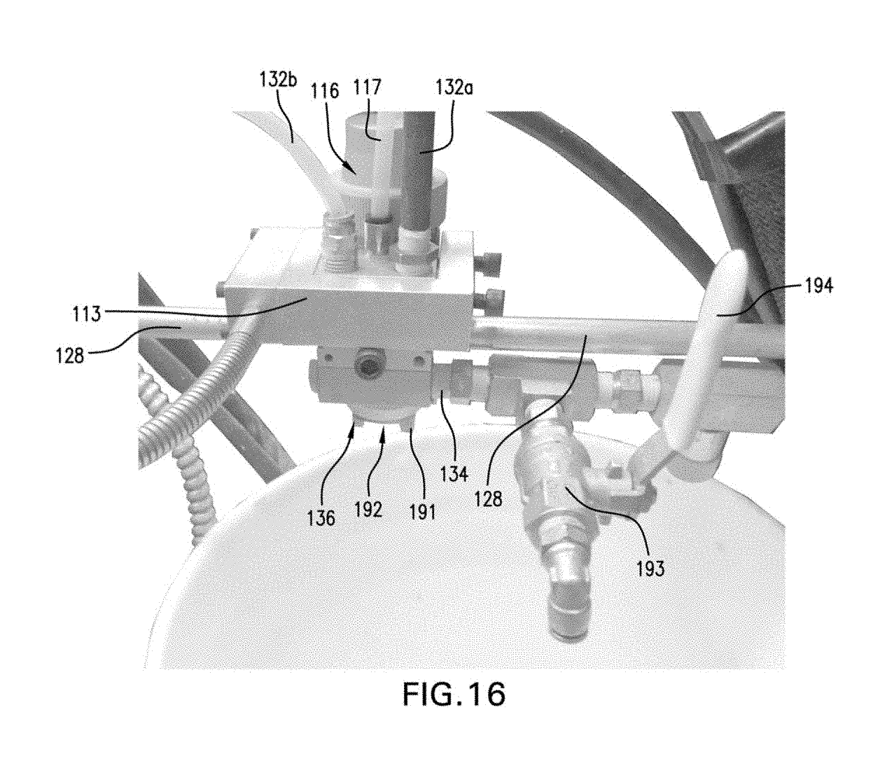

FIGS. 13-16 show an example of the applicator 116 and the system 100. FIG. 13 shows the applicator 116 with the applicator heater 113 partially surrounding the applicator body 184. FIGS. 14-15 show the applicator 116 and the applicator heater 113 attached to the frame arm 128. Also shown is the manifold 131 from which the heated hose 130 connects and the air lines 132a, 132b exit. FIG. 16 shows a purge valve 193 disposed along the adhesive line 134. The purge valve 193 can be selectively activated via a lever 194 so as to drain adhesive 103 from the adhesive line 134 to prevent clogging.

FIG. 17 shows the power and control system 117. The power and control system 117 is connected to the power source 124 at the power input 106, the air preparing system 110, the applicator 116, and the adhesive preparing system 112. As described above, the power and control system 117 is configured to supply power to and control the operation of a plurality of the components in system 100.

In the depicted embodiment, the power and control system 117 is configured to monitor and control four separate zones: zone 1, zone 2, zone 3, and zone 4. The zones represent different components in the adhesive application system 100. The power and control system 117 is configured to receive inputs from sensors located in each zone, and alter the operating characteristics of each zone depending on the values measured by the sensors. In some embodiments, the sensors are temperature sensors such as RTD 143 of the air heater 129, sensor 150 on the heated hose 130, RTD 178 on the adhesive heater 162, and the temperature sensor 115 on the applicator heater 113. In some embodiments, power and control system 117 can control and monitor more or less zones.

In one example, the zones represent the heat sources in the adhesive application system 100. For example, zone 1 represents the heated hose 130, zone 2 represents the applicator heater 113, zone 3 represents the adhesive heater 162, and zone 4 represents air heater 129. Each zone can be set at a preset temperature, and the power and control system 117 will monitor and adjust the power being sent to the various components to maintain such a preset temperature. In one embodiment, zone 1 is preset to maintain a temperature of about 400 degrees Fahrenheit, zone 2 is preset to maintain a temperature of about 150 degrees Fahrenheit, zone 3 is preset to maintain a temperature of about 150 degrees Fahrenheit, and zone 4 is preset to maintain a temperature of about 400 degrees Fahrenheit. The power and control system 117 can also monitor and power a variety of other different components of the adhesive application system 100, such as spraying parameters.

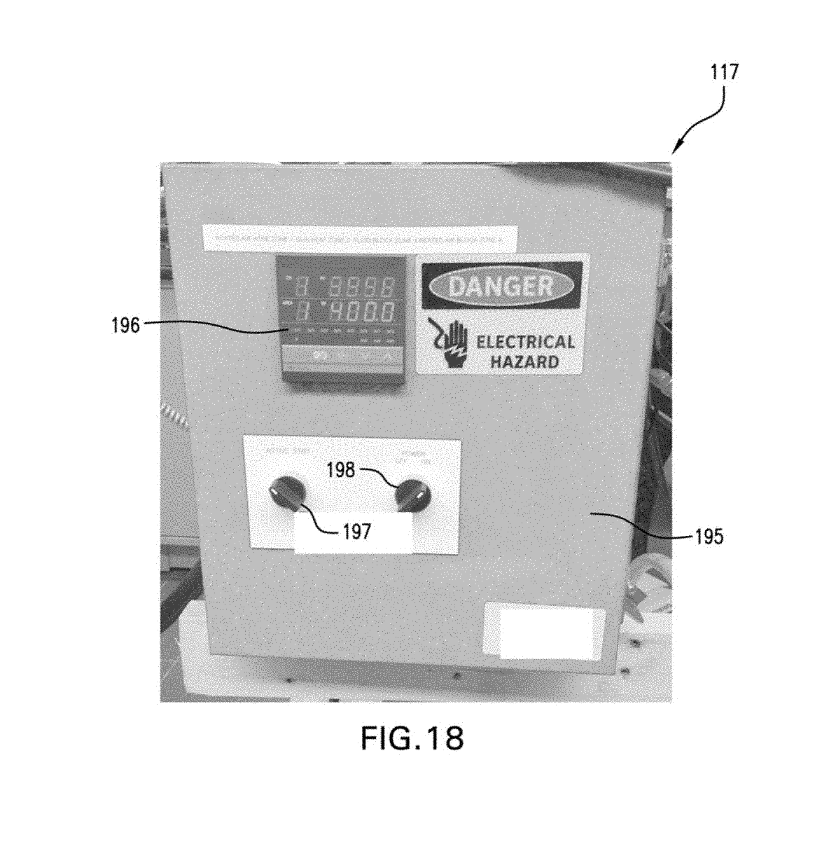

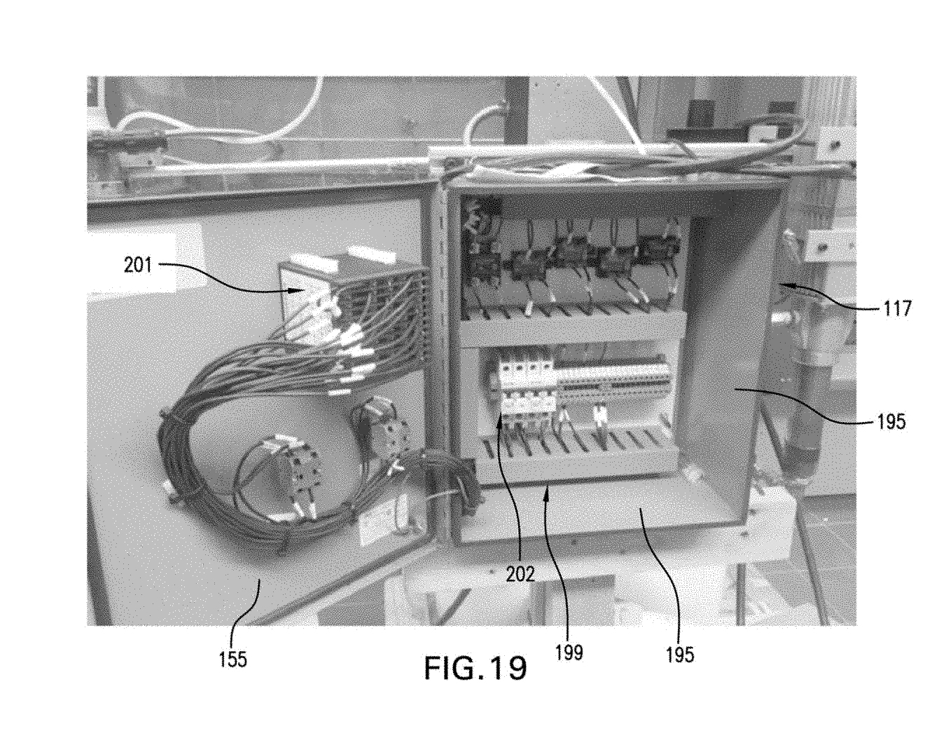

FIGS. 18 and 19 show an example power and control system 117. The power and control system 117 includes a housing 195, a readout 196, a standby knob 197, and a power switch 198. The housing 195 is configured to store related electronics 199 of the power and control system 117. For example, the electronics 199 can include a microprocessor 201 and connection terminals 202 to connect components of the adhesive application system 100 to the power and control system 117.

The readout 196 is configured to display the preset temperature value of each of the zones along with the real-time measured value for each zone.

The standby knob activates a standby setting where the power and control system 117 operates each zone in a low-power state but does not shut down power to each zone. This allows the system 100 to be quickly powered up to its full operation state quickly.

As briefly described above, the adhesive application system 100 is configured to apply a liquid adhesive (i.e. an adhesive that is liquid at room temperature). The adhesive has a carrier that can be volatilized with heat (e.g. water, solvent, or mixtures thereof). The adhesive application system 100 can be used to apply any liquid adhesive 103 that uses a carrier (i.e., water based, solvent based, etc.). The adhesive 103 can be an emulsion, a dispersion or a solution and can include any polymer type including homopolymers and polymers comprising one or more monomer (e.g., copolymers, terpolymers, etc.). The water based liquid adhesive can be borated (i.e. boric acid can added to it).

Some common monomers that can be used to make water-based adhesives include, e.g., vinyl acetate, vinyl chloride, vinyl acrylics, vinylidene chloride, ethylene, ethyl acrylate, ethyl hexyl acrylate, butyl acrylate, methyl acrylate, methyl methacrylate, styrene, and urethanes. The adhesive 103 can further use any protection system (i.e. be stabilized in a number of different ways) including polyvinyl alcohol, surfactant and cellulose.

The viscosity of the adhesive 103 can be no greater than about 5000 cps, no greater than about 2500 cps, no greater than about 2000 cps, no greater than about 1600 cps, between about 300 and about 2000 cps, or even between about 500 and about 1600 cps when tested at 26° C. using a Brookfield Viscometer (20 rpm, spindle=3). The solids of the adhesive 103 can be from about 45% to about 65%, from about 45% to about 60%, or even from about 45% to about 55% by weight.

In one embodiment, the adhesive 103 can be a water-based emulsion including polyvinyl alcohol as the protection system (i.e., the water-based adhesive is polyvinyl alcohol stabilized).

The polymer present in the emulsion can be a polyvinyl acetate (PVA) homopolymer, a vinyl acetate-ethylene (VAE) copolymer, a vinyl acrylic, a styrene acrylic, a polychloroprene, a block copolymer, a styrene butadiene rubber, an olefin or a starch based polymer.

The water-based emulsion can include a plasticizer. The plasticizer can comprise phthalates (e.g., diisodecyl phthalate (DIDP), diisooctyl phthalate (DIOP), etc.), benzoates (e.g., diethylene glycol dibenzoate, dipropylene glycol dibenzoate, and mixtures thereof) and triacetin. The plasticizer can be present at from about 3% to about 20% by weight, from about 5% to about 15% by weight, or even from about 7% to about 13% by weight.

FIG. 20 shows a chart containing characteristics of example adhesives 103 that can be used with the adhesive application system 100.

The following test methods were used to generate the data in FIG. 20

Solids

Total solids of the polymer emulsion was determined by first weighing an aluminum weighing dish to the nearest milligram. The polymer emulsion to be tested was mixed or stirred to insure homogeneity. One gram+/−0.2 grams of the polymer emulsion was added to the dish and dried in an oven for 1.5 to 2.5 hours at a temperature of 130° C. The sample was cooled for approximately 5 minutes and reweighed. An average of at least two samples not differing by more than 0.3% was recorded.

Viscosity

Viscosity is determined using Brookfield viscometer model RVT at 20 rotations per minute. An appropriate spindle is chosen to obtain an accurate reading based on the anticipated viscosity of the composition and the manufacturer's recommendations. The sample composition is maintained at 25° C. and the measurement is taken within 1 hour of making the composition. The results are reported in centipoise (cps).

Set Time

The adhesive was applied in a spray pattern to a piece of recycled chip board (recycled content of 40-60%) utilizing the claimed application system with the following conditions: adhesive temperature: 65.6° C. (150° F.), air temperature: 190.5° C.-204.4° C. (375-400° F.); gun pressure: 70 psi: atomization pressure: 2-30 psi. Immediately after application, a second piece of chip board was pressed into place using hand pressure. The Set Time was determined by pulling the bond at various times after formation until 100% of the bond line resulted in fiber tear from the chip board.

Spray Pattern

The spray pattern observed during the set time test was given a ranking on a scale from 1 (poor) to 10 (excellent). A score of 10 was given to an adhesive exhibiting a finely atomized spray with no globules (larger bits of adhesive). Lower numbers indicate that more globules were present.

Nozzle Clogging

Nozzles were merely observed during spraying and if they clogged were give a Yes and if they did not clog were given a No.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A system for applying an adhesive, the system comprising:
a. an air flow path for conveying compressed air,
b. an adhesive flow path for conveying liquid adhesive;
c. an air heater coupled to the air flow path and configured to heat the compressed air;
d. a liquid adhesive heater coupled to the adhesive flow path and configured to heat the liquid adhesive; and
e. an applicator positioned downstream from the air and liquid adhesive heaters,
the applicator being configured to receive the liquid adhesive from the adhesive flow path and the compressed air from the air flow path, the applicator being further configured to spray the liquid adhesive from the applicator using the compressed air.

2. The system of claim 1, further comprising a heating air line extending along at least a portion of the air flow path downstream of the air heater and configured to heat the compressed air.

3. The system of claim 2, wherein the heating air line is a heated hose configured to heat at least the portion of the air flow path downstream of the air heater and to the applicator.

4. The system of claim 1, further comprising a compressor for providing compressed air along the air flow path, wherein the air heater is downstream from the compressor.

5. The system of claim 1, further comprising a pump for providing a flow of liquid adhesive from a source of liquid adhesive along the adhesive flow path, wherein the liquid adhesive heater is downstream from the pump.

6. The system of claim 1, further comprising an applicator heater positioned at the applicator and configured to heat at least a portion of the applicator

7. The system of claim 1, wherein the applicator includes a compressed air recirculation port for receiving the compressed air from the air flow path to heat at least a portion of the applicator.

8. The system of claim 1, wherein the liquid adhesive is polyvinyl alcohol stabilized water-based emulsion adhesive.

9. The system of claim 1, wherein the system is operable in a spray mode in which the applicator is configured to spray the liquid adhesive, and is also operable in a bead mode in which the applicator is configured to apply a bead of the liquid adhesive to a surface.

10. The system of claim 1, wherein the air heater and liquid adhesive heater are block heaters.

11. The system of claim 1, further comprising a control system that is configured to monitor and adjust a temperature of at least the air heater and the liquid adhesive heater.

12. The system of claim 1, wherein the liquid adhesive is a water-based adhesive that includes a plasticizer.

13. A system for applying an adhesive, the system comprising:
a. an air flow path for conveying compressed air,
b. an adhesive flow path for conveying liquid adhesive;
c. an air heater coupled to the air flow path and configured to heat the compressed air;
d. a heating air line extending along at least a portion of the air flow path downstream of the air heater and configured to heat the compressed air; and
e. an applicator positioned downstream from the air heater and heating air line, the applicator being configured to receive the liquid adhesive from the adhesive flow path and the compressed air from the air flow path, and further configured to spray the liquid adhesive from the applicator using the compressed air.

14. The system of claim 13, further comprising a compressor for providing compressed air along the air flow path, wherein the air heater is downstream from the compressor.

15. The system of claim 13, wherein the heating air line is a heated hose configured to heat at least a portion of the air flow path downstream of the air heater.

16. The system of claim 15, wherein the heated hose is configured to maintain a compressed air temperature of between about 350 degrees Fahrenheit and 450 degrees Fahrenheit along at least the portion of the air flow path downstream of the air heater temperature.

17. The system of claim 15, wherein the heated hose includes heated metal coils running the length of the heated hose between the air heater and the applicator.

18. A method of applying a water-based adhesive, the method comprising:
a. receiving compressed air into an air flow path;
b. pumping liquid adhesive from a source of liquid adhesive into an adhesive flow path;
c. heating the compressed air in the compressed air flow path using an air heater,
d. heating the compressed air along at least a portion of the air flow path downstream of the air heater using a heating air line;
e. receiving the liquid adhesive from the adhesive flow path and the compressed air from the air flow path at an applicator, and
f. spraying the liquid adhesive from the applicator using the compressed air.

19. The method of claim 18, further comprising heating the applicator using a block heater.
